(19) United States
(12) Patent Application Publication
(10) Pub. No.: US 2006/0235856 A1
(43) Pub. Date: Oct. 19, 2006

(54) Route generation for task completion by a location-aware device

(76) Inventors: Michael Austin Halcrow, Pflugerville, TX (US); Dustin C. Kirkland, Austin, TX (US); David Bruce Kumhyr, Austin, TX (US)

Correspondence Address: IBM CORP (YA);C/O YEE & ASSOCIATES PC, P.O. BOX 802333, DALLAS, TX, 75380, US

(21) Appl. No.: 11/014,053

(22) Filed: Dec. 16, 2004

(51) Int. Cl. G06F 7/00

(52) U.S. Cl. 707/100

(57) ABSTRACT

A method, apparatus, and computer instructions for a portable data processing system for generating a route for completing a set of tasks. A location of the portable device is identified. A route for completing the set of tasks is identified based on a policy and the location to form a completion route. The completion route for the set of tasks is then presented.

### BACKGROUND OF THE INVENTION

1. Technical Field

The present invention relates generally to an improved data processing system, and in particular to a method, apparatus, and computer instructions for processing data. Still more particularly, the present invention relates generally to a method, apparatus, and computer instructions for generating a route to complete tasks.

2. Description of Related Art

The Internet is a global network of computers and networks joined together by means of gateways that handle data transfer and the conversion of messages from a protocol of the sending network to a protocol used by the receiving network. The Internet has revolutionized both communications and commerce, as well as being a source of both information and entertainment. For many users, email is a widely used format to communicate over the Internet. Additionally, the Internet is also used for real-time voice conversations.

With respect to transferring data over the Internet, the World Wide Web environment is used. This environment is also referred to simply as “the Web”. The Web is a mechanism used to access information over the Internet. In the Web environment, servers and clients effect data transaction using the hypertext transfer protocol (HTTP), a known protocol for handling the transfer of various data files, such as text files, graphic images, animation files, audio files, and video files.

A browser is a program used to look at and interact with all of the information on the Web. A browser is able to display Web pages and to traverse links to other Web pages. Resources, such as Web pages, are retrieved by a browser, which is capable of submitting a request for the resource. This request typically includes an identifier, such as, for example, a universal resource locator (URL). As used herein, a browser is an application used to navigate or view information or data in any distributed database, such as the Internet or the World Wide Web.

The browser includes a user interface, which is a graphical user interface (GUI) that allows the user to interface or communicate with another browser. This interface provides for selection of various functions through menus and allows for navigation. For example, a menu may allow a user to perform various functions, such as saving a file, opening a new window, displaying a history, and entering a URL.

The user of browsers for accessing the Web has traditionally been the domain of desktop and laptop computers. Today, many types of mobile or portable devices may access the Web. For example, mobile phones and personal digital assistants (PDAs) commonly connect to the Internet to access information. A device that is able to access information on the Web is considered to be a Web enabled device. These devices may be used to access e-mail and other personal organization applications. Further, users of mobile phones and PDAs that are Web enabled may obtain maps and directions to various locations. Mobile phones and PDAs combine the ability to access the Web with other features, such as, address books, calendars, task managers, and calculators. For example, a user may have a set of chores to perform at different locations. These chores may be entered into a task manager and checked off or removed when chores are completed. Further, the user may enter addresses for the different locations to obtain a map of set of directions to a location for which a particular chore is to be performed. Although all of these actions may be performed using a portable device such as a PDA, the entry of all of the information needed for the chores and to obtain directions can be time consuming.

It would be advantageous to have an improved method, apparatus, and computer instructions for managing tasks and identifying routes for the tasks using Web enabled portable devices.

### SUMMARY OF THE INVENTION

The present invention provides an improved method, apparatus, and computer instructions for a portable data processing system for generating a route for completing a set of tasks. A location of the portable device is identified. A route for completing the set of tasks is identified based on a policy and the location to form a completion route. The completion route for the set of tasks is then presented.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram illustrating a network data processing system in which the present invention may be implemented in accordance with a preferred embodiment of the present invention;

FIG. 2 is a block diagram of a data processing system that may be implemented as a server in accordance with a preferred embodiment of the present invention;

FIG. 3 is a diagram of a mobile telephone in accordance with a preferred embodiment of the present invention;

FIG. 4 is a block diagram of a camera phone in accordance with a preferred embodiment of the present invention;

FIG. 5 is a diagram of a client in the form of a personal digital assistant (PDA) in accordance with a preferred embodiment of the present invention;

FIG. 6 is a block diagram of a PDA is shown in accordance with a preferred embodiment of the present invention;

FIG. 7 is a diagram of components used for generating optimum routes for completing tasks in accordance with a preferred embodiment of the present invention;

FIG. 8 is a diagram of a set of tasks in accordance with a preferred embodiment of the present invention;

FIG. 9 is a diagram illustrating a route for completing tasks in accordance with a preferred embodiment of the present invention;

FIG. 10 is a diagram illustrating a map identifying a route for reaching locations for tasks in accordance with a preferred embodiment of the present invention;

FIG. 11 is a flowchart of a process for generating a route in accordance with a preferred embodiment of the present invention; and

FIG. 12 is a flowchart of a process for generating a new route in accordance with a preferred embodiment of the present invention.

### DETAILED DESCRIPTION OF THE PREFERRED EMBODIMENT

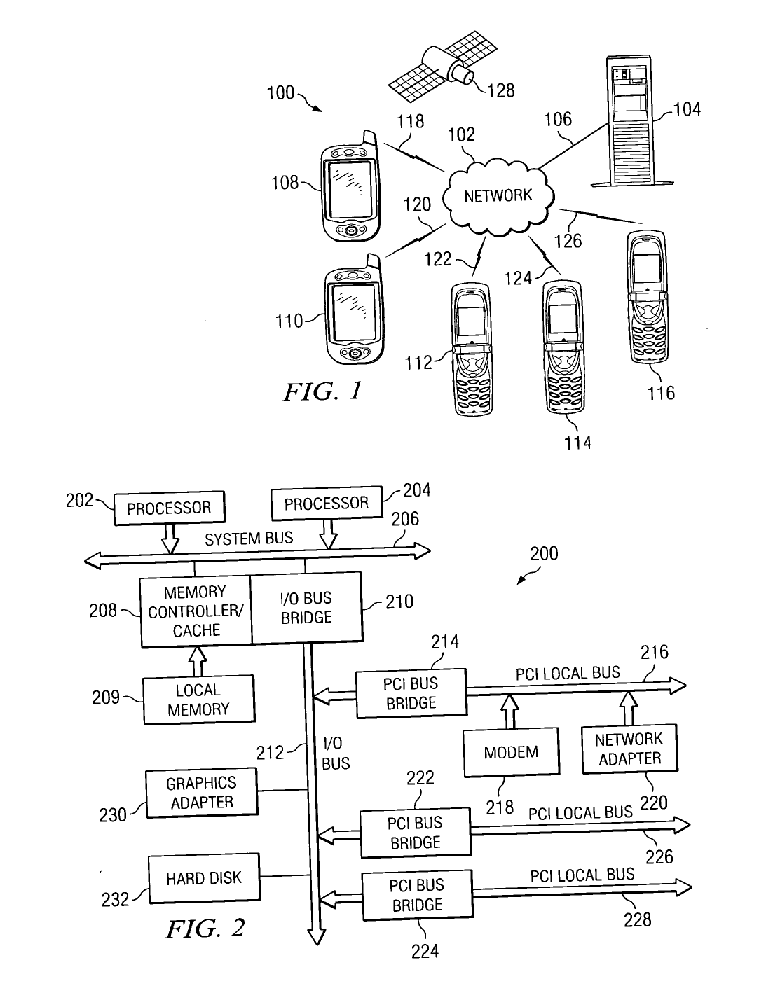

With reference not to the figures, and in particular FIG. 1, a diagram illustrating a network data processing system is depicted in accordance with a preferred embodiment of the present invention. Network data processing system 100 includes network 102, which is the medium used to provide communications links between various devices and computers connected together within network data processing system 100. Network 102 may include connections, such as wire, wireless communication links, or fiber optic cables.

Server 104 is connected to network 102 through communications link 106. In the depicted example, server 104 provides data, such as boot files, operating system images, and applications to clients, such as PDA 108, PDA 110, mobile phone 112, mobile phone 114, and mobile phone 116. These clients are mobile or portable devices, connected to network 102 through wireless communications links 118, 120, 122, 124, and 126. Through these wireless communications links, the clients are able to access information from server 104, such as Web sites or databases.

Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Additionally, clients 108, 110, 112, 114, and 116 also include global positioning system (GPS) capabilities that allow these clients to be aware of their location through information receive from a global positioning system 128. A global positioning system is a worldwide satellite navigational system formed by satellites orbiting the earth and their corresponding receivers on the earth. The global positioning system satellites continuously transmit digital radio signals that contain data on the satellite location and the exact time to the earth-bound receivers, such as clients 108, 110, 112, 114, and 116.

Based on this information the receivers know how long it takes for the signal to reach the receiver on earth. As each signal travels, the longer it takes the receiver to get the signal, the farther away the satellite is. By knowing how far away a satellite is, the receiver knows that it is located somewhere on the surface of an imaginary sphere centered at the satellite. By using three satellites, a global positioning system can calculate the longitude and latitude of the receiver based on where the three spheres intersect. By using four satellites, a global positioning system can also determine altitude.

The present invention recognizes that information from global positioning system 128 along with task managers may be used to calculate an optimum route to accomplish a set of tasks. The mechanism of the present invention uses the location of a portable data processing system, such as PDA 108 or mobile phone 110, to generate a route or order in which tasks are to be performed based on a policy. As used herein, a policy is a set of rules, parameters, and/or preferences used to give a priority or ordering for tasks based on the properties of the tasks.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

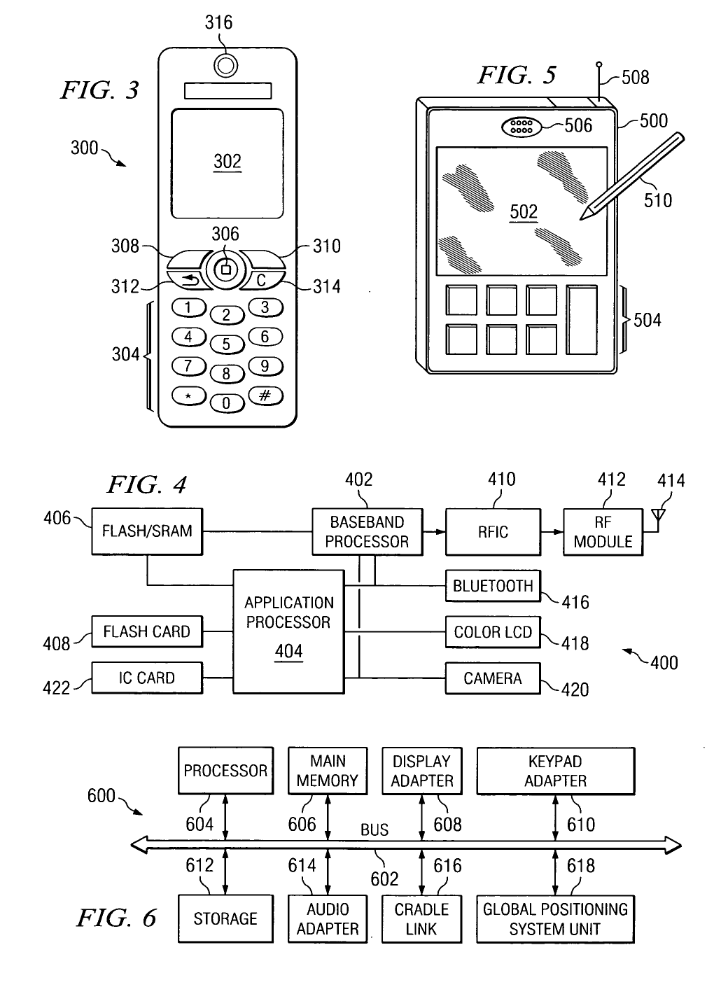

With reference now to FIG. 3, a diagram of a mobile telephone is depicted in accordance with a preferred embodiment of the present invention. Mobile phone 300 is an example of a portable data processing system in which the present invention may be implemented. Mobile phone 300 includes screen 302, which is capable of displaying pictures and text. Additionally, mobile phone 300 also includes numeric keypad 304, joystick 306, and buttons 308, 310, 312, and 314 placed around the joystick 306. These buttons are used to initiate various functions in mobile phone 300. These functions include, for example, activating a menu, displaying a calendar, or initiating a call. Mobile phone 300 also includes camera 316, which may be used to take pictures or videos depending on the implementation.

Turning next to FIG. 4, a block diagram of a camera phone is depicted in accordance with a preferred embodiment of the present invention. Camera phone 400 includes baseband processor 402, application processor 404, flash/static random access memory (SRAM) 406, flash card 408, radio frequency integrated circuit (RFIC) 410, radio frequency (RF) module 412, antenna 414, Bluetooth unit 416, color liquid crystal display (LCD) 418, camera 420, and IC card 422.

Baseband processor 402 provides for receiver and transmitter operations and is also referred to as a transceiver. In particular, baseband processor 402 handles all of the audio, signal, and data processing needed to receive and send data using RF transmissions or Bluetooth transmissions. Application processor 404 provides the processing power for other functions within camera phone 400. For example, calculators, calendars, alarms, camera functions, and directories are provided through application processor 404. Flash/SRAM 406 is a storage device in which various instructions for providing the functions within camera phone 400 are located and provide upgrades. Flash card 408 is a storage device in which user data and applications may be stored. An example of flash card 408 is a secure digital card.

A pathway for the transmission of voice and other types of data is through RFIC 410. Additionally, short range transmissions may be sent or received through Bluetooth unit 416. Bluetooth unit 416 conforms to Bluetooth wireless specification, which defines the link layer and application layer for product developers. Both of these transmissions are made through antenna 414 in this illustrative example.

Color LCD 418 provides a display for pictures and other data for camera phone 400. Camera 420, in this example, is a complementary metal oxide semiconductor (CMOS) camera, which may be built into camera phone 400 or connected to camera phone 400 as a module, such as IC card 422. IC card 422 also may contain other application specific functions, such as a global positioning system or other functions, such as a modem or additional memory. Camera 420 forms the camera module of camera phone 400, while the other components form the digital phone module of camera phone 400 in these illustrative examples.

With reference now to FIG. 5, a diagram of a client in the form of a personal digital assistant (PDA) is depicted in accordance with a preferred embodiment of the present invention. PDA 500 is an example of a portable data processing system in which the present invention may be implemented. PDA 500 includes a display 502 for presenting textual and graphical information. Display 502 may be a known display device, such as a liquid crystal display (LCD) device. The display may be used to present a map or directions, calendar information, a telephone directory, or an electronic mail message. In these examples, screen 502 may receive user input using an input device such as, for example, stylus 510.

PDA 500 may also include keypad 504, speaker 506, and antenna 508. Keypad 504 may be used to receive user input in addition to using screen 502. Speaker 506 provides a mechanism for audio output, such as presentation of an audio file. Antenna 508 provides a mechanism used in establishing a wireless communications link between PDA 500 and a network, such as network 202 in FIG. 2.

PDA 500 also preferably includes a graphical user interface that may be implemented by means of systems software residing in computer readable media in operation within PDA 500.

Turning now to FIG. 6, a block diagram of a PDA is shown in accordance with a preferred embodiment of the present invention. PDA 600 is an example of a PDA, such as PDA 500 in FIG. 5, in which code or instructions implementing the processes of the present invention may be located. PDA 600 includes a bus 602 to which processor 604 and main memory 606 are connected. Display adapter 608, keypad adapter 610, storage 612, and audio adapter 614 also are connected to bus 602. Cradle link 616 provides a mechanism to connect PDA 600 to a cradle used in synchronizing data in PDA 600 with another data processing system. Further, display adapter 608 also includes a mechanism to receive user input from a stylus when a touch screen display is employed.

An operating system runs on processor 604 and is used to coordinate and provide control of various components within PDA 600 in FIG. 6. The operating system may be, for example, a commercially available operating system such as Windows CE, which is available from Microsoft Corporation. Instructions for the operating system and applications or programs are located on storage devices, such as storage 612, and may be loaded into main memory 606 for execution by processor 604. PDA 600 also includes global positioning system unit 618. This unit is employed to provide location information for PDA 600.

Those of ordinary skill in the art will appreciate that the hardware in FIG. 6 may vary depending on the implementation. Other internal hardware or peripheral devices, such as flash ROM (or equivalent nonvolatile memory) or optical disk drives and the like, may be used in addition to or in place of the hardware depicted in FIG. 6.

Turning next to FIG. 7, a diagram of components used for generating optimum routes for completing tasks is depicted in accordance with a preferred embodiment of the present invention. In this example, route generator 700 is a software component or a set of circuitry that is used to identify a route for which tasks, such as tasks 702 should be completed or performed. Route generator 700 may be located in a portable device such as camera phone 400 in FIG. 4 or PDA 600 in FIG. 6.

In the illustrative example, tasks 702 are received by route generator 700. Route generator 700 uses global positioning system unit 704 to identify the location of the portable device in which route generator 700 is located. Alternatively, the location of the portable device also may be identified through a user input. Based on the properties of tasks 702 and the identified location, policy 706 and map database 708 are used to identify an optimal route for completing tasks 702. A route, as used herein, is a set of tasks placed in an order. In these examples, properties for tasks 702 include, locations, deadlines, and actions to be performed. Policy 706 is employed to provide in ordering for tasks 702 to create an optimum route for the user to accomplish tasks 702.

Policy 706 is a set of rules, parameters, and/or preferences used by route generator 700 to process tasks 702 in conjunction with the current location of the portable device using global positioning system unit 702. For example, policy 706 may include a rule in which priorities for tasks are based on deadlines. Another rule may be included in which the location of tasks are next used to determine which tasks are to be performed first. Additionally, policy 706 may include a rule in which tasks of a selected type are to be performed before tasks of other types. For example, if a bank deposit is to be made and dropping mail at a post office is to be performed, policy 706 may place the bank deposit prior to the dropping of mail if no particular deadline is present for these two tasks.

Route generator 700 also uses the location of the portable device and accesses map database 708 in conjunction with policy 706 to generate route 710 for presentation to the user. Additionally, if a task in tasks 702 does not specify a particular location, route generator 700 may select a location to perform the tasks based on the location of the portable device and any designated locations for performing other tasks. Route generator 700 may revise route 710 when tasks in tasks 702 are completed or in response to changes in the location of the portable device.

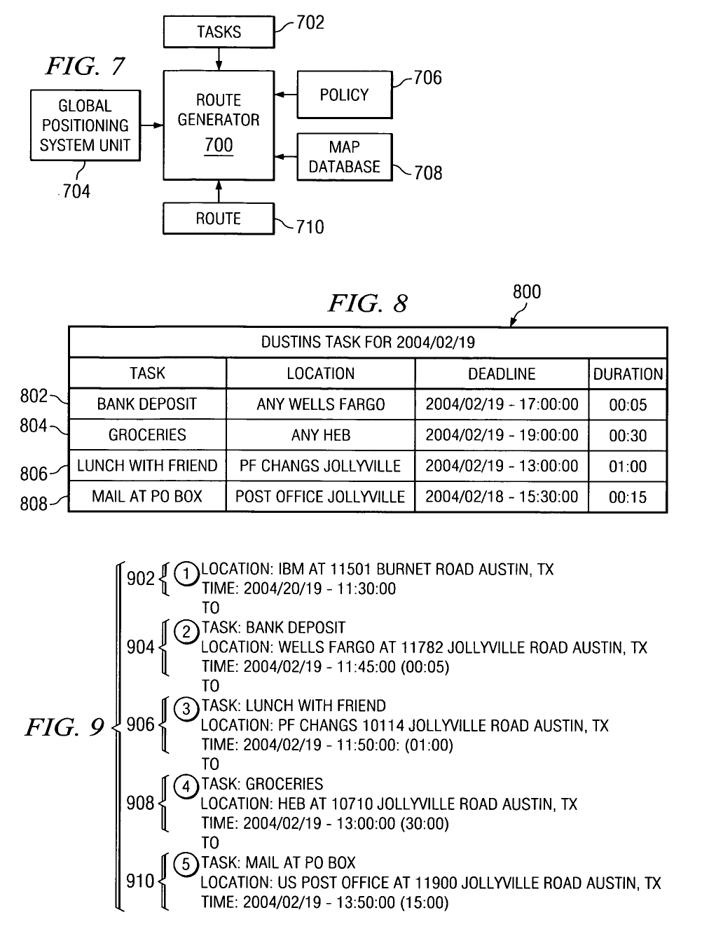

Turning next to FIG. 8, a diagram of a set of tasks is depicted in accordance with a preferred embodiment of the present invention. Tasks 800 are an example of tasks such as tasks 702 in FIG. 7. As illustrated, tasks 800 include entries 802, 804, 806, and 808. Each of these entries identifies a task, a location, a deadline for performing the task, and an identification of how long the task should take.

Entry 802 contains a bank deposit task that may be performed at any Wells Fargo bank by 5:00 pm. This task is estimated to take 5 minutes. Entry 804 contains a grocery task that may be performed at any HEB by 7:00 pm with the task taking about 30 minutes. Entry 806 identifies lunch at PF Changs in Jollyville that has a deadline of 1:00 pm that should take about 1 hour. Entry 808 contains a task to send mail at a post office in Jollyville that should be performed at the latest by 2:30 pm with a duration of 15 minutes.

Tasks 800 are processed using a route generator, such as route generator 700 in FIG. 7. Turning to FIG. 9, a diagram illustrating a route for completing tasks is depicted in accordance with a preferred embodiment of the present invention. Route 900 contains entries 902, 904, 906, 908, and 910. In this example, entry 902 contains the current location of the portable device.

In generating route 900, the policy used takes into account specified locations in tasks 800. Two of the entries specified locations in Jollyville, while the other two entries do not require any specific geographic location. Entry 802 in FIG. 8 states that any Wells Fargo bank may be used, and entry 804 in FIG. 8 stated that any HEB may be used. In this case, the routing process identifies locations in Jollyville to accomplish the tasks that are not specific with respect to geographic locations.

Entry 902 shows the current location of the portable device. Entries 904, 906, 908, and 910 are all specified as to be performed along Jollyville Road. The routing process selects locations to perform tasks and places the tasks into the order shown to meet the different deadlines and locations for performing the tasks. In generating route 900, the duration of the tasks also are taken in to account.

Route 900 may be presented to the user in the form shown. Additionally, other formats also may be used to present route 900. For example, a map identifying the locations for the tasks also may be presented to the user on the portable device.

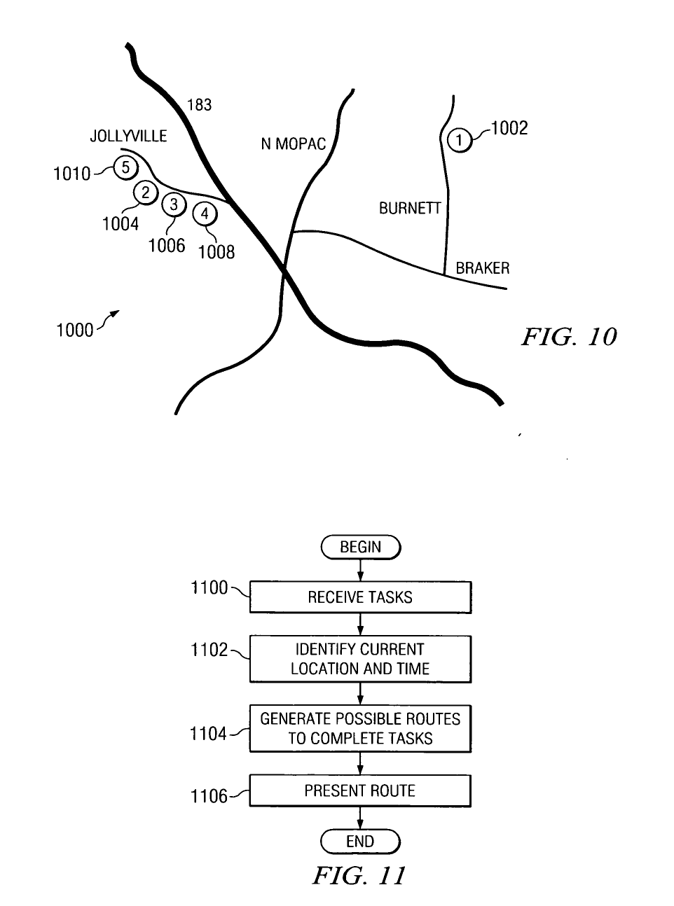

Next, in FIG. 10, a diagram illustrating a map identifying a route for reaching locations for tasks is depicted in accordance with a preferred embodiment of the present invention. Map 1000 shows the current location of the portable device at point 1002. Point 1004 corresponds to entry 904 for a bank deposit. Point 1006 corresponds to entry 906 for lunch at PF Changs. Point 1008 corresponds to entry 908 for groceries. Point 1010 corresponds to entry 910 for sending mail at the post office. Map 1000 is displayed or presented in conjunction with route 900 in FIG. 9 in these examples.

Turning now to FIG. 11, a flowchart of a process for generating a route is depicted in accordance with a preferred embodiment of the present invention. The process illustrated in FIG. 11 may be implemented in a route generation component, such as route generator 700 in FIG. 7.

The process begins by receiving tasks (step 1100). The current location of the portable device and the current time are identified (step 1102). A route to complete the tasks is generated (step 1104). Step 1104 is performed using the properties of the tasks and a policy. Properties, such as the location, deadline, and duration of a task are used to generate the route. For example, specific locations may be selected for tasks that do not specify specific locations to optimize the completion of all of the tasks in the event that locations are specified for other tasks. If a task is specified to be performed at a particular location in a city, locations for other tasks may be identified in a manner such that these other tasks are in locations close by to the specified location. Further, the order in which tasks are performed are selected to minimize the amount of traveling and time spent in these examples. The particular order of the locations is selected to ensure that the tasks can be completed based on the properties of the tasks. This order may vary, depending on various rules, parameters, and/or preferences in the policy.

The process presents the route to be used (step 1106) thus ending the process. In these examples, the route is presented to the user on the portable device, such as a mobile phone, laptop computer, or PDA.

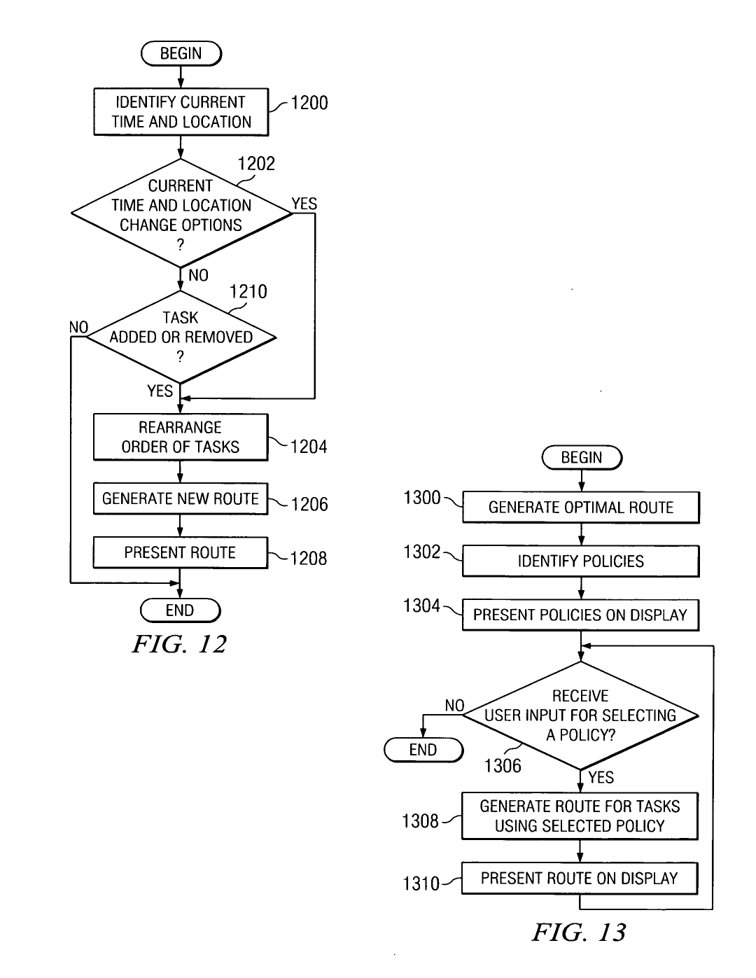

Turning to FIG. 12, a flowchart of a process for generating a new route is depicted in accordance with a preferred embodiment of the present invention. The process illustrated in FIG. 12 may be implemented in a route generation component, such as route generator 700 in FIG. 7. This process is initiated after a route is generated by the process in FIG. 11.

The process begins by identifying the current time and location of the portable device (step 1200). A determination is made as to whether the current time and location has changed one or more options (step 1202). An option is a possible location or time in which a task may be accomplished. For example, if a location of a task, such as lunch in entry 906 in FIG. 9, changes, the options for other tasks also may change. In this example, the task for groceries may change to another location that is closer to the new location for the lunch. These options also may include changes in traffic related information. For example, if conditions change because of traffic conditions, a new route may be identified. Further, these traffic patterns may be anticipated or actual reported traffic patterns based on the current time and location.

If one or more options have changed, the process rearranges the order of tasks (step 1204). Next, a new route is generated (step 1206). The process presents the new route (step 1208) with the process terminating thereafter.

Turning back to step 1202, if one or more options have not changed, a determination is made as to whether a task has been added or removed. If a task has been added or removed the process proceeds to step 1204 as described above. Otherwise, the process terminates. In this manner, a route may be dynamically modified such that the order and location of tasks may change. For example, if the user takes a detour from the presented route, the new location of the user may result in a change in the order of task or a change in the location of tasks based on the current location and time of the portable device.

Turning to FIG. 13, a flowchart of a process for presenting alternative routes is depicted in accordance with a preferred embodiment of the present invention. The process illustrated in FIG. 13 may be implemented in a route generation component, such as route generator 700 in FIG. 7.

The process begins by generating an optimal route (step 1300). In this illustrative example, the route is generated without using any particular policy. Then, the process identifies policies that may be present (step 1302). The identified policies are presented on a display (step 1304). Next, a determination is made as to whether user input for selecting a policy has been received (step 1306). If a users input for selecting a policy has been received, the process generates a route for tasks using the selected policy (step 1306). A route is presented on display (step 1308) with the process returning to step 1306.

With reference again to step 1306, if a user input selecting a policy is not present, the process terminates. The process in FIG. 13 may be used to present alternative routes for completing tasks based on different policies. For example, one policy may specify performing a particular task second, regardless of whether this ordering is most efficient. Another policy may prefer purchasing tasks that include purchases be performed prior to other types of tasks. This policy would result in the generation of another route. Additionally, the policy may include a reordering of tasks, resulting in the generation of yet another route.

In this manner, routes generated by changes in policies may be presented to a user. The user may then select one of the routes for actual use.

Thus, the present invention provides an improved method, apparatus, and computer instructions for generating optimal routes to complete a set of tasks in a location-aware portable device. The mechanism of the present invention uses the current location of the portable device and a set of tasks to generate a route for performing those tasks. The mechanism of the present invention may automatically modify the route based on factors, such as current location, current time, and tasks still present for completion.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, the route generation component described as being located in the portable device. This component also may be located in a remote location, such as a Webserver or other server process. In this type of implementation, the portable device may send location information and the set of tasks to the server. A route is generated at the server and then returned to the portable device for presentation. Although specific policies are given as examples, the present invention may be implemented using many different policies. For example, one policy may state that highway travel is to be avoided. Another policy may specify that tasks involving the purchase of sale items should occur before other types of tasks. In another example, a policy may include a bias towards certain business establishments over others. A user may prefer a particular chain of grocery stores over others. Other policies may be based on weather or traffic conditions. These different policies may be combined to form a single combined policy for identifying routes.

Additionally, the mechanism of the present invention may automatically mark tasks as completed when the mechanism detects that the user has stopped in the vicinity of a location on the route. Alternatively, the tasks may be marked as pending/completed for the user to verify that the task has been completed. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a portable data processing system for generating a route for completing a set of tasks, the method comprising:
providing a location of the portable data processing system;
identifying a route for completing the set of tasks based on a policy and the location to form a completion route; and
presenting the completion route on the portable data processing system.

2. The method of claim 1 further comprising:
providing a new location of the portable data processing system to create a change in location of the portable data processing system;
responsive to the change in the location, revising the completion route based on the policy to form a revised completion route; and
presenting the revised completion route on the portable data processing system.

3. The method of claim 1 further comprising:
responsive to a change in the policy, revising the completion route to form a revised completion route; and
presenting the revised completion route in the portable data processing system.

4. The method of claim 1 further comprising:
responsive to a change in time, revising the completion route to form a revised completion route; and
presenting the revised completion route on the portable data processing system.

5. The method of claim 1, wherein the portable data processing system is selected from one of a mobile phone, a laptop computer, or a personal digital assistant.

6. The method of claim 1, wherein the policy includes a rule identifying priorities for types of tasks.

7. The method of claim 1, wherein the policy includes a rule identifying a preference for types of roads in the completion route.

8. The method of claim 1, wherein the providing step is accomplished by sensing the position of the portable data processing system.

9. The method of claim 1, wherein the providing step is accomplished by user input to the portable data processing system.

10. The method of claim 1 further comprising:
providing a new task to be added to the set of tasks while the portable data processing system is mid-route on the completion route;
responsive to the addition of the new task, revising the completion route based on the policy to form a revised completion route; and
presenting the revised completion route on the portable data processing system.

11. A portable data processing system for generating a route for completing a set of tasks, the portable data processing system comprising:
providing means for providing a location of the portable data processing system;
identifying means for identifying a route for completing the set of tasks based on a policy and the location to form a completion route; and
presenting means for presenting the completion route on the portable data processing system.

12. The portable data processing system of claim 11 further comprising:
providing means for providing a new location of the portable data processing system to create a change in location of the portable data processing system;
revising means, responsive to the change in the location, for revising the completion route based on the policy to form a revised completion route; and
presenting means for presenting the revised completion route on the portable data processing system.

13. The portable data processing system of claim 11 further comprising:
revising means, responsive to a change in the policy, for revising the completion route to form a revised completion route; and
presenting means for presenting the revised completion route on the portable data processing system.

14. The portable data processing system of claim 11 further comprising:
revising means, responsive to a change in time, for revising the completion route to form a revised completion route; and
presenting means for presenting the revised completion route on the portable data processing system.

15. The portable data processing system of claim 11, wherein the portable data processing system is selected from one of a mobile phone, a laptop computer, or a personal digital assistant.

16. The portable data processing system of claim 11, wherein the policy includes a rule identifying priorities for types of tasks.

17. The portable data processing system of claim 11, wherein the policy includes a rule identifying a preference for types of roads in the completion route.

18. The portable data processing system of claim 11, wherein the providing means is accomplished by sensing the position of the portable data processing system.

19. The portable data processing system of claim 11, wherein the providing means is accomplished by user input to the portable data processing system.

20. The portable data processing system of claim 11 further comprising:
providing means for providing a new task to be added to the set of tasks while the portable data processing system is mid-route on the completion route;
revising means, responsive to the addition of the new task, for revising the completion route based on the policy to form a revised completion route; and
presenting means for presenting the revised completion route on the portable data processing system.

21. A computer program product in a computer readable medium for generating a route for completing a set of tasks, the computer program product comprising:
first instructions for providing a location of a portable data processing system;
second instructions for identifying a route for completing the set of tasks based on a policy and the location to form a completion route; and
third instructions for presenting the completion route on the portable data processing system.

22. The computer program product of claim 21 further comprising:
fourth instructions for providing a new location of the data processing system to create a change on location of the portable data processing system;
fifth instructions for responsive to the change in the location, revising the completion route based on the policy to form a revised completion route; and
sixth instructions for presenting the revised completion route on the portable data processing system.

23. The computer program product of claim 21 further comprising:
fourth instructions, responsive to a change in the policy, for revising the completion route to form a revised completion route; and
fifth instructions for presenting the revised completion route in the portable data processing system.

24. The computer program product of claim 21 further comprising:
fourth instructions, responsive to a change in time, for revising the completion route to form a revised completion route; and
fifth instructions for presenting the revised completion route on the portable data processing system.

25. The computer program product of claim 21, wherein the portable data processing system is selected from one of a mobile phone, a laptop computer, or a personal digital assistant.

26. The computer program product of claim 21, wherein the policy includes a rule identifying priorities for types of tasks.

27. The computer program product of claim 21, wherein the policy includes a rule identifying a preference for types of roads in the completion route.

28. The computer program product of claim 21, wherein the first instructions is accomplished by sensing the position of the portable data processing system.

29. The computer program product of claim 21, wherein the first instructions is accomplished by user input to the portable data processing system.

30. The computer program product of claim 21 further comprising:
fourth instructions for providing a new task to be added to the set of tasks while the portable data processing system is mid-route on the completion route;
fifth instructions for responsive to the addition of the new task, revising the completion route based on the policy to form a revised completion route; and
sixth instructions for presenting the revised completion route on the portable data processing system.
